(19) United States
(12) Patent Application Publication
(10) Pub. No.: US 2021/0318567 A1
(43) Pub. Date: Oct. 14, 2021

(54) LIGHT ADJUSTING GLASS AND METHOD FOR MANUFACTURING THE SAME

(71) Applicants: Beijing BOE Optoelectronics Technology Co., Ltd., Beijing (CN); BOE TECHNOLOGY GROUP CO., LTD., Beijing (CN)

(72) Inventor: Xiaojuan WU, Beijing (CN)

(21) Appl. No.: 17/262,801

(22) PCT Filed: May 18, 2020
(86) PCT No.: PCT/CN2020/090783

§ 371 Date: Jan. 25, 2021

(30) Foreign Application Priority Data
May 24, 2019 (CN) 201910442176.5

(51) Int. Cl. G02F 1/1339; G02F 1/1333; G02F 1/1341; G02F 1/1343

(52) U.S. Cl. CPC G02F 1/13394; G02F 1/133305; G02F 2202/04; G02F 1/134309; G02F 2202/06; G02F 1/1341

(57) ABSTRACT

The present disclosure provides a light adjusting glass and a method for manufacturing the light adjusting glass, and the light adjusting glass includes: a first substrate and a second substrate which are disposed opposite to each other, a liquid crystal layer and a retaining wall which are interposed between the first substrate and the second substrate, where liquid crystal molecules in the liquid crystal layer are deflected under an action of an electric field generated between the first substrate and the second substrate so as to control a light transmittance of the light adjusting glass; the retaining wall is in a grid shape and is configured to maintain a cell thickness between the first substrate and the second substrate during the light adjusting glass being bent, liquid crystal molecules in the liquid crystal layer are uniformly dispersed in grids of the retaining wall.

### CROSS REFERENCE TO RELATED APPLICATIONS

The present application claims priority to Chinese patent application No. 201910442176.5, filed on May 24, 2019, the contents of which are incorporated herein by reference in their entirety.

### TECHNICAL FIELD

The present disclosure relates to the technical field of intelligent glass, and particularly, relates to a light adjusting glass and a method for manufacturing the light adjusting glass.

### BACKGROUND

At present, light adjusting glasses are more and more widely applied in the fields of building and traffic, and the fields of automobile, high-speed train, passenger aircraft and the like are interest in a light adjusting glass with dye liquid crystal. Products such as PDLC (polymer dispersed liquid crystal) intelligent glass, electro-chromic intelligent glass and the like exist in an intelligent glass market. The PDLC intelligent glass can only realize switching between transparency and haze, and does not block light or heat; the electro-chromic intelligent glass has problems of complex film layer process, slow response speed (8 s to 20 s), bluish color in a dark state and the like. The light adjusting glass with dye liquid crystal realizes switching between a bright state and a dark state by utilizing a selective absorption of dichroic dye molecules in liquid crystal to light, and compared with a conventional PDLC intelligent glass and a conventional electro-chromic intelligent glass, greatly improves optical properties such as black state purity, response speed and the like. When the light adjusting glass is applied to a side window of a high-speed train and the like, an automobile skylight or glasses, the light adjusting glass needs to have a certain radian, that is, the light adjusting glass needs to have a flexible characteristic. However, when the existing light adjusting glass with dye liquid crystal realizes a curvature for the radian, due to an occurrence of deformation for the curvature, dye liquid crystal molecules flow, and thicknesses of liquid crystal cell of the light adjusting glass in different areas are different, resulting in a macroscopic expression of uneven brightness, thereby affecting a usage of the light adjusting glass.

### SUMMARY

An embodiment of the present disclosure provides a light adjusting glass, including: a first substrate and a second substrate which are disposed opposite to each other, a liquid crystal layer and a retaining wall which are interposed between the first substrate and the second substrate, where,

liquid crystal molecules in the liquid crystal layer are deflected under an action of an electric field generated between the first substrate and the second substrate so as to control a light transmittance of the light adjusting glass;

the retaining wall is in a grid shape, and is configured to maintain a cell thickness between the first substrate and the second substrate during the light adjusting glass being bent, the liquid crystal molecules in the liquid crystal layer are uniformly dispersed in grids of the retaining wall.

In some implementations, the liquid crystal layer is doped with reactive monomer, and the retaining wall is generated by irradiating the reactive monomer with light of a particular wavelength.

In some implementations, the light of the particular wavelength includes UV light.

In some implementations, the liquid crystal layer includes dye liquid crystal molecules.

In some implementations, the first substrate includes a first base, and a first electrode disposed on a side of the first base proximal to the liquid crystal layer;

the second substrate includes a second base, and a second electrode disposed on a side of the second base proximal to the liquid crystal layer; where,

the first base and the second base are both flexible bases.

In some implementations, a material of the flexible bases includes polyimide or polyethylene terephthalate.

In some implementations, the first substrate includes a first base, and a first electrode disposed on a side of the first base proximal to the liquid crystal layer;

the second substrate includes a second base, and a second electrode disposed on a side of the second base proximal to the liquid crystal layer; where,

the first electrode and the second electrode are both plate-shaped electrodes.

An embodiment of the present disclosure further provides a method for manufacturing the light adjusting glass described above, and the method includes:

forming a first substrate and a second substrate; filling a liquid crystal layer and forming a retaining wall between the first substrate and the second substrate, where the retaining wall is in a grid shape and is configured to maintain a cell thickness between the first substrate and the second substrate during the light adjusting glass being bent, liquid crystal molecules in the liquid crystal layer are uniformly dispersed in grids of the retaining wall.

In some implementations, the filling the liquid crystal layer and forming the retaining wall between the first substrate and the second substrate includes:

doping reactive monomer in the liquid crystal molecules, and filling the liquid crystal molecules doped with the reactive monomer between the first substrate and the second substrate;

irradiating a particular area of the first substrate or the second substrate by using light with a particular wavelength so that the reactive monomer forms the retaining wall.

In some implementations, the light of the particular wavelength includes UV light.

### DESCRIPTION OF DRAWINGS

FIG. 1 is a schematic diagram of a light adjusting glass being not bent and in a bright state according to an embodiment of the present disclosure;

FIG. 2 is a schematic diagram of a light adjusting glass being bent and in a bright state according to an embodiment of the present disclosure;

FIG. 3 is a schematic diagram of a light adjusting glass being not bent and in a dark state according to an embodiment of the present disclosure;

FIG. 4 is a schematic diagram of a light adjusting glass being bent and in a dark state according to an embodiment of the present disclosure;

FIG. 5 is a schematic structural diagram of a retaining wall of a light adjusting glass according to an embodiment of the present disclosure; and

FIG. 6 is a flowchart of manufacturing a light adjusting glass according to an embodiment of the present disclosure.

### DESCRIPTION OF EMBODIMENTS

In order to make technical solutions of the present disclosure better understood by a person skilled in the art, the technical solutions of the present disclosure are described in further detail below with reference to the accompanying drawings and embodiments.

Unless defined otherwise, technical or scientific terms used herein shall have the ordinary meaning as understood by one of ordinary skill in the art to which the present disclosure belongs. The use of “first”, “second”, and the like in the present disclosure is not intended to indicate any order, quantity, or importance, but rather is used to distinguish one element from another. Furthermore, terms “a”, “an”, or “the” and similar referents do not denote a limitation of quantity, but rather denote a presence of at least one. The word “including” or “includes”, and the like, is intended to mean that an element or item preceding the word contains an element or item listed after the word and its equivalent, but not an exclusion of other elements or items. Terms “coupled” or “coupling” and the like are not restricted to physical or mechanical connections, but may include electrical connections, whether direct or indirect. Terms “upper”, “lower”, “left”, “right”, and the like are used only to indicate relative positional relationships, and when an absolute position of an object being described is changed, the relative positional relationships may also be changed accordingly.

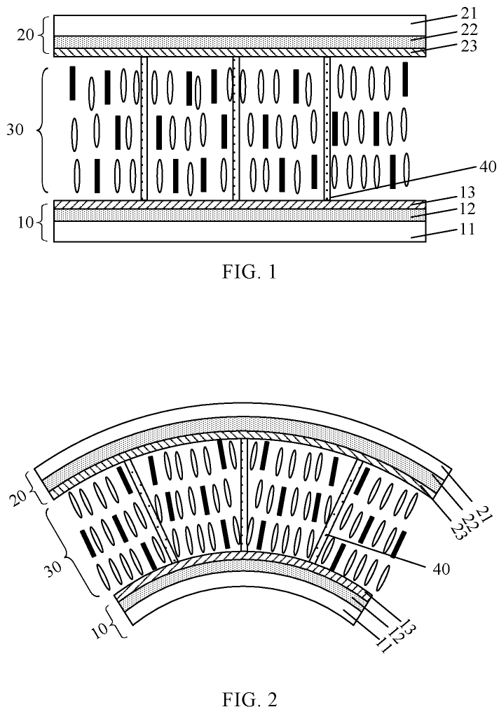

As shown in FIGS. 1 to 5, an embodiment of the present disclosure provides a light adjusting glass, which may be a flexible light adjusting glass or a light adjusting glass with a certain radian; the light adjusting glass includes a first substrate 10 and a second substrate 20 which are disposed opposite to each other, and a liquid crystal layer 30 and a retaining wall 40 which are interposed between the first substrate 10 and the second substrate 20; the retaining wall 40 in the present embodiment is in a grid shape, and liquid crystal molecules in the liquid crystal layer 30 are uniformly dispersed in grids of the retaining wall 40; the liquid crystal molecules in the liquid crystal layer 30 are deflected by an electric field between the first substrate 10 and the second substrate 20 to control a light transmittance of the light adjusting glass.

It should be noted that, in the present embodiment, the grids of the retaining wall 40 in the grid shape are arranged in an array, and sizes of the grids are uniform or approximately uniform, as shown in FIG. 5.

Since the retaining wall 40 in the light adjusting glass of the present embodiment is in the grid shape, and the liquid crystal molecules in the liquid crystal layer 30 can be uniformly dispersed in the grids of the retaining wall 40, even when the light adjusting glass is bent so that the liquid crystal molecules flow around, each grid of the retaining wall 40 can limit the liquid crystal molecules therein, so that the liquid crystal molecules of the liquid crystal layer 30 are kept relatively uniform, and a problem of non-uniform thickness of the light adjusting glass caused by the liquid crystal molecules flowing when the light adjusting glass is bent is effectively avoided. Certainly, it should be understood that the retaining wall 40 may also maintain a cell thickness of the light adjusting glass when the light adjusting glass is not bent.

The liquid crystal layer 30 in the present embodiment may be doped with reactive monomer 4, and the retaining wall 40 in the present embodiment may be generated by irradiating the reactive monomer 4 with light of a particular wavelength. The light of the particular wavelength may be UV light. The reactive monomer 4 may specifically be acrylate monomer; certainly, other reactive monomers that can be polymerized may be irradiated with UV light to form the retaining wall 40. How to obtain the retaining wall 40 from the reactive monomer 4 will be more specifically described later.

The liquid crystal layer in the present embodiment may specifically include dye liquid crystal molecules, that is, include liquid crystal molecules and doped dichroic dye molecules. In such case, the doped dichroic dye molecules may also be uniformly dispersed in the respective grids of the retaining wall 40.

An example of a specific structure of the above-described light adjusting glass is given below.

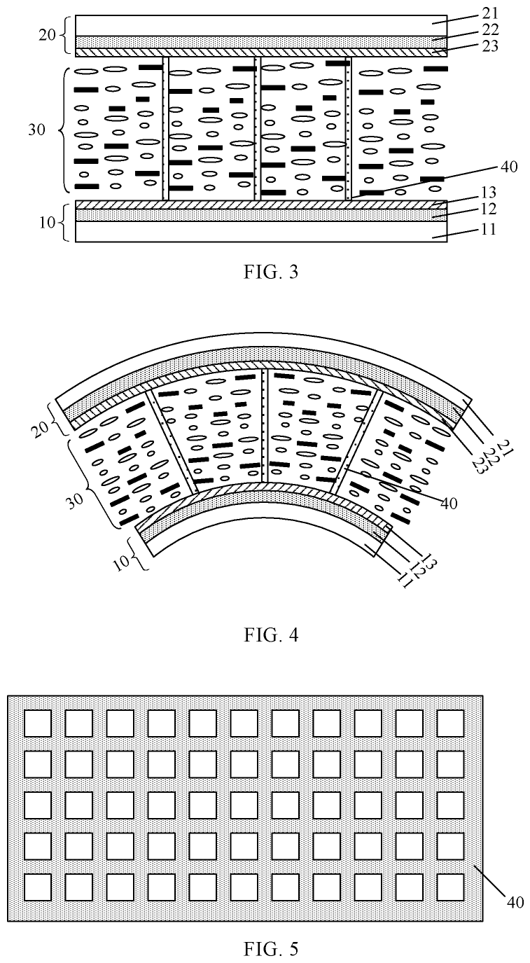

For example, the light adjusting glass of the present embodiment of the present disclosure may include a first substrate 10 and a second substrate 20 which are disposed opposite to each other, and a liquid crystal layer 30 and a retaining wall 40 in a grid shape, which are interposed between the first substrate 10 and the second substrate 20. The first substrate 10 of the light adjusting glass includes a first base 11, a first electrode 12 and a first alignment layer 13 which are sequentially disposed on a side of the first base 11 proximal to the liquid crystal layer 30, the second substrate 20 of the light adjusting glass includes a second base 21 disposed opposite to the first base 11, and a second electrode 22 and a second alignment layer 23 sequentially disposed on a side of the second base 21 proximal to the first base 11; the liquid crystal layer 30 is interposed between the first alignment layer 13 and the second alignment layer 23; the liquid crystal layer 30 includes dye liquid crystal, i.e., includes liquid crystal molecules and doped dichroic dye molecules. The first electrode 12 and the second electrode 22 may both be plate-shaped electrodes, i.e., the light adjusting glass may be a VA liquid crystal cell. Alignment directions of the first alignment layer 13 and the second alignment layer 23 are perpendicular to each other, that is, pretilt angles of the liquid crystal molecules in the liquid crystal layer 30 with respect to the first alignment layer 13 and the second alignment layer 23 are different by 90°. When no voltage is applied to the first electrode 12 and the second electrode 22, the liquid crystal molecules and the dichroic dye molecules in the liquid crystal layer 30 are aligned perpendicular to the first substrate 10 and the second substrate 20, so that incident light can transmit through the light adjusting glass, and the light adjusting glass is in a bright state, the light adjusting glass not being bent is as shown in FIG. 1 and being bent is as shown in FIG. 2; when voltages are applied to the first electrode 12 and the second electrode 22, an electric field is generated between the first electrode 12 and the second electrode 22, and the liquid crystal molecules and the dichroic dye molecules are controlled to be aligned parallel to the first substrate 10 and the second substrate 20, and the incident light along a direction of long axis of the dichroic dye molecules is absorbed, so that the light adjusting glass is in a dark state, the light adjusting glass not being bent is as shown in FIG. 3 and being bent is as shown in FIG. 4. Certainly, when voltages are applied to the first electrode 12 and the second electrode 22, the electric field generated between the first electrode 12 and the second electrode 22 may control the liquid crystal molecules and the dichroic dye molecules to be aligned at an acute angle or an obtuse angle with respect to the first substrate 10 and the second substrate 20, and in such case, a portion of light can transmit through the light adjusting glass, so that the light adjusting glass is in a gray scale state.

If the light adjusting glass is a flexible light adjusting glass, the first base 11 and the second base 21 are flexible bases. A specific material of the flexible bases may be PI (polyimide) or PET (polyethylene terephthalate). Certainly, other flexible materials may be used, and different materials may be selected according to specific application scenarios of the light adjusting glass. Further, the first base 11 and the second base 21 of the light adjusting glass in the present embodiment are not limited to the flexible bases, and may be glass bases, quartz bases, or the like.

In the present embodiment, the first electrode 12 and the second electrode 22 being both plate-shaped electrodes is taken as an example. That is, the first electrode 12 and the second electrode 22 may form a VA type electric field there-between when a voltage is applied therebetween. Certainly, when the liquid crystal molecules are positive liquid crystal molecules, the first electrode 12 and the second electrode 22 may form a TN type electric field there-between when a voltage is applied therebetween. In addition, in the embodiment, the first electrode 12 and the second electrode 22 may be both disposed on the first base 11, and in such case, the first electrode 12 and the second electrode 22 are sequentially disposed in a direction away from the first base 11, the first electrode 12 may be a plate electrode, the second electrode 22 may be a slit electrode, and when voltages are applied to the first electrode 12 and the second electrode 22, an FFS type (or ADS type) electric field may be formed. Certainly, the first electrode 12 and the second electrode 22 may be disposed on the first base 11 at intervals in a same layer, and in such case, the first electrode 12 and the second electrode 22 may form an IPS type electric field there-between when a voltage is applied therebetween.

An embodiment of the present disclosure further provides a method for manufacturing a light adjusting glass, which can be used for manufacturing the light adjusting glass in the above embodiment. The method includes: forming a first substrate 10 and a second substrate 20; filling a liquid crystal layer 30 and forming a retaining wall 40 between the first substrate 10 and the second substrate 20, where the retaining wall 40 is in a grid shape and is configured to maintain a cell thickness between the first substrate 10 and the second substrate 20 when the light adjusting glass is bent, liquid crystal molecules in the liquid crystal layer 30 are uniformly dispersed in grids of the retaining wall 40.

Since the retaining wall 40 of the light adjusting glass formed by in the present embodiment is in the grid shape, and the liquid crystal molecules of the liquid crystal layer 30 can be uniformly dispersed in the grids of the retaining wall 40, even when the light adjusting glass is bent so that the liquid crystal molecules flow around, each grid of the retaining wall 40 can limit the liquid crystal molecules therein, so that the liquid crystal molecules of the liquid crystal layer 30 are kept relatively uniform, and a problem of non-uniform thickness of the light adjusting glass caused by the liquid crystal molecules flowing when the light adjusting glass is bent is effectively avoided.

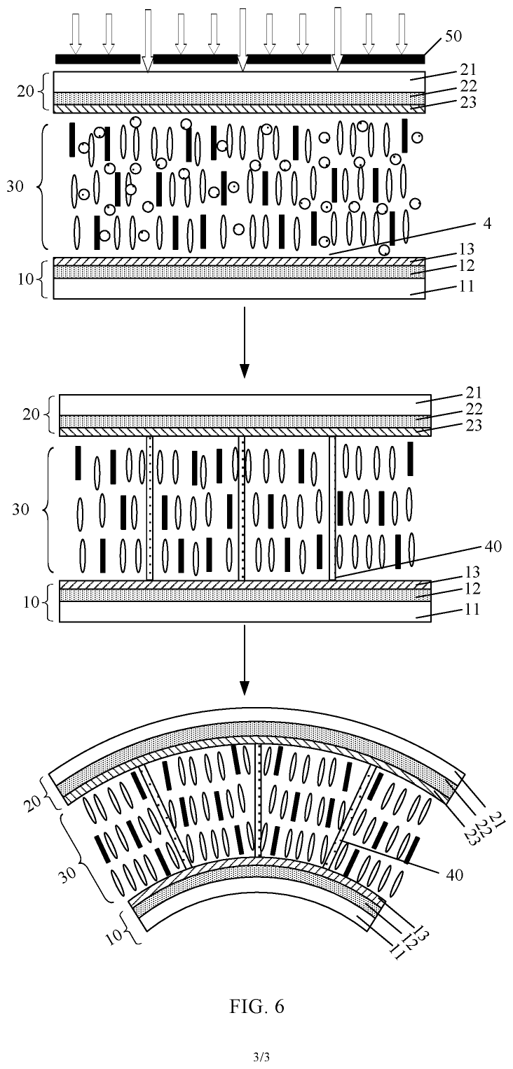

A specific example of the method for manufacturing the light adjusting glass in the present embodiment is given below with reference to FIG. 6. Specifically, the method includes the following steps S1 to S3.

S1, forming electrodes on entire surfaces of the first base 11 and the second base 21, respectively, that is, forming the first electrode 12 on the first base 11, and forming the second electrode 22 on the second base 21.

S2, sequentially coating PI solution and performing a rubbing process on the first electrode 12 and the second electrode 22 to form a first alignment layer 1325 and a second alignment layer 23; where rubbing directions of the first alignment layer 13 and the second alignment layer 23 are antiparallel.

S3, coating frame sealing glue on the second base 21 formed with the second alignment layer 23, mixing liquid crystal molecules, dichroic dye molecules, and reactive monomer 4 to form a mixture, and dropping the mixture on the first alignment layer 13; then aligning and assembling the first base 11 and the second base 21 to form a liquid crystal cell, and curing the frame sealing glue through ultraviolet light and heat; irradiating a middle area of the first base 11 through a grid-shaped mask 50 so that the reactive monomer 4 which is not irradiated moves toward the area irradiated with the UV light and combines with the reactive monomer 4 in the area irradiated with the UV light to form the grid-shaped polymer retaining wall 40, and a thickness of the retaining wall 40 (a dimension in a direction perpendicular to the first base 11 and the second base 21) is consistent with a thickness of the liquid crystal cell of the light adjusting glass (a dimension in a direction perpendicular to the first base 11 and the second base 21). Furthermore, the light adjusting glass can be bent.

When the light adjusting glass with dye liquid crystal manufactured by the above method is bent, the dye liquid crystal is fixed in different micro-areas (grids) by the polymer retaining wall and cannot flow to periphery, and meanwhile, thicknesses of the polymer retaining wall in different areas are consistent, so that thicknesses of different areas of the liquid crystal cell of the light adjusting glass are still consistent when the light adjusting glass is bent, that is, the light adjusting glass has an uniform brightness, and different areas of the light adjusting glass are optically uniform. When the light adjusting glass is bent, different areas of the light adjusting glass are uniform in brightness when the light adjusting glass is in the bright state, and different areas of the light adjusting glass are uniform in brightness when the light adjusting glass is in the dark state.

It should be understood that the above embodiments are merely exemplary embodiments employed to illustrate the principles of the present disclosure, and the present disclosure is not limited thereto. It will be apparent to those skilled in the art that various changes and modifications can be made therein without departing from the spirit and scope of the present disclosure, and these changes and modifications are to be considered within the scope of the present disclosure.

1. A light adjusting glass, comprising: a first substrate and a second substrate which are disposed opposite to each other, a liquid crystal layer and a retaining wall which are interposed between the first substrate and the second substrate, wherein,
liquid crystal molecules in the liquid crystal layer are deflected under an action of an electric field generated between the first substrate and the second substrate so as to control a light transmittance of the light adjusting glass;
the retaining wall is in a grid shape, and is configured to maintain a cell thickness between the first substrate and the second substrate during the light adjusting glass being bent, the liquid crystal molecules in the liquid crystal layer are uniformly dispersed in grids of the retaining wall.

2. The light adjusting glass according to claim 1, wherein the liquid crystal layer is doped with reactive monomer, and the retaining wall is formed by irradiating the reactive monomer with light of a particular wavelength.

3. The light adjusting glass according to claim 2, wherein the light of the particular wavelength comprises ultraviolet light.

4. The light adjusting glass according to claim 1, wherein the liquid crystal layer comprises dye liquid crystal molecules.

5. The light adjusting glass according to claim 1, wherein the first substrate comprises a first base, and a first electrode disposed on a side of the first base proximal to the liquid crystal layer;
the second substrate comprises a second base and a second electrode disposed on a side of the second base proximal to the liquid crystal layer; wherein,
the first base and the second base are both flexible bases.

6. The light adjusting glass according to claim 5, wherein a material of the flexible bases comprises polyimide or polyethylene terephthalate.

7. The light adjusting glass according to claim 1, wherein the first substrate comprises a first base, and a first electrode disposed on a side of the first base proximal to the liquid crystal layer;
the second substrate comprises a second base and a second electrode disposed on a side of the second base proximal to the liquid crystal layer; wherein,
the first electrode and the second electrode are both plate-shaped electrodes.

8. A method for manufacturing the light adjusting glass according to claim 1, comprising:
forming a first substrate and a second substrate;
filing a liquid crystal layer and forming a retaining wall between the first substrate and the second substrate, the retaining wall is in a grid shape, and is configured to maintain a cell thickness between the first substrate and the second substrate during the light adjusting glass being bent, liquid crystal molecules in the liquid crystal layer are uniformly dispersed in grids of the retaining wall.

9. The method according to claim 8, wherein the filing the liquid crystal layer and forming the retaining wall between the first substrate and the second substrate comprises:
doping reactive monomer in the liquid crystal molecules, and filling the liquid crystal molecules doped with the reactive monomer between the first substrate and the second substrate;
irradiating a specific area of the first substrate or the second substrate by using light with a particular wavelength to polymerize the reactive monomer to form the retaining wall.

10. The method according to claim 9, wherein the light of the particular wavelength comprises ultraviolet light.
